(19) United States
(12) Patent Application Publication
(10) Pub. No.: US 2021/0239161 A1
(43) Pub. Date: Aug. 5, 2021

(54) BEARING INCLUDING A COATING INCLUDING AN INTEGRATED NANOSENSOR

(71) Applicant: AKTIEBOLAGET SKF, Goteborg (SE)

(72) Inventors: Benoît Hauvespre, Saint Etienne de Chigny (FR); Samuel Viault, Saint-Antoine-du-Rocher (FR)

(21) Appl. No.: 17/126,214

(22) Filed: Dec. 18, 2020

(30) Foreign Application Priority Data
Jan. 31, 2020 (FR) 2000961

(51) Int. Cl. F16C 41/00; F16C 19/14; F16C 33/58

(52) U.S. Cl. CPC F16C 41/00; F16C 2233/00; F16C 33/583; F16C 19/14

(57) ABSTRACT

A bearing, such as a plain bearing or a rolling bearing, including at least one coating on at least one surface of at least one element of the bearing, the at least one coating including at least one sensor that is integrated into the coating, the sensor being a nanosensor that includes at least one nanoparticle.

### CROSS-REFERENCE

This application claims priority to French patent application no. 2000961 filed on Jan. 31, 2020, the contents of which are fully incorporated herein by reference.

### TECHNICAL FIELD

The present disclosure is directed to the general field of the recovery, in particular from rotating parts, of information such as temperature, force, vibrations, rotation speed, humidity, lubricant quality, etc.

### BACKGROUND

The present disclosure finds one particular application in the field of bearings, such as rolling bearings, for example ball bearings, roller bearings, needle bearings, and also plain bearings having no rolling elements, which are used in particular in cam followers, etc.

In order to ensure that bearings function correctly and to improve their service life it is known to use sensors to monitor conditions of the bearing, and in particular optical fibers capable of detecting the load transmitted to said bearing.

However, the integration of sensors or optical fibers is particularly constraining since they generally project relative to the elements of the bearing. Moreover, these various sensors are difficult to position effectively on the bearing.

There exists a need to improve the monitoring of the state of the bearings.

### SUMMARY

Embodiments of the present invention aim to remedy these disadvantages.

An aspect of the disclosure comprises a bearing including at least one coating including at least one sensor integrated into said coating, said sensor being a nanosensor includes at least one nanoparticle.

As used herein, the terms “nanoparticle sensor” and “nanosensor” describe any sensor effecting an operation at the nanometric scale and configured to transmit a signal on a macroscopic scale.

By “nanoparticle” is meant a three-dimensional nano-object of which are on a nanometric scale, that is to say a particle the nominal diameter of which is less than approximately 100 nm.

A nanoparticle may for example include graphene.

Graphene is a two-dimensional carbon film only one atom thick that is characterized by exceptional chemical electrical, material, optical and physical properties. Consequently, graphene and associated materials, such as graphene oxide and reduced graphene oxide, have come to the forefront in the field of detection.

Hybrid graphene-nanoparticle structures can act synergistically to offer a certain number of unique physical-chemical properties that are desirable and advantageous for detection applications. These hybrid graphene-nanoparticle structures are of particular interest because not only do they have the individual properties of nanoparticles and graphene, but they can also have additional synergistic properties and therefore offer improved sensitivity and selectivity that can be produced using a variety of detection mechanisms.

In another variant, a nanoparticle may be of the fluorescent carbon nanoparticle type (FCNP) that is able to change color.

In a further variant, a nanoparticle may be produced based on thermoplastic polymers and may for example include a coloring agent based on Rhodamine B.

The type of nanoparticle is not limited to the examples cited hereinabove and may be any nano-object the three dimensions of which are on a nanometric scale, that is to say a particle the nominal diameter of which is less than approximately 100 nm.

In accordance with one embodiment, including at least one exterior ring and one interior ring, the coating is disposed on at least one element of the bearing.

For example, the bearing may be a rolling bearing or a sliding (plain) bearing.

For example, the coating may be disposed radially between the exterior ring and the interior ring.

For example, the coating may be deposited on the interior surface and/or the exterior surface of the exterior ring.

For example, the coating may be deposited on the interior surface and/or the exterior surface of the interior ring.

The bearing advantageously includes at least one row of rolling elements disposed radially in raceways respectively formed on the exterior surface of the interior ring and the interior surface of the exterior ring and a cage configured to maintain the circumferential spacing between said rolling elements. The coating is disposed on each of the rolling elements and/or on the cage.

For example, the bearing may include two rows of rolling elements.

The rolling elements are, for example, balls. Alternatively, other types of rolling elements could be provided, such as for example rollers or needles.

For example, the bearing may include at least one sealing element mounted radially between the exterior and interior rings, the coating being situated on at least one part the sealing element, such as, for example, on a sealing lip in rubbing contact with the interior ring.

In accordance with another embodiment, the bearing is a plain bearing, and the coating is disposed on the exterior surface and/or on the bore of said plain bearing.

In accordance with another aspect, the disclosure concerns a coating configured to be deposited on at least one element of a bearing and including at least one sensor integrated into said coating, said sensor being a nanosensor includes at least one nanoparticle.

For example, the coating may be deposited on a surface by vacuum deposition techniques, for example by physical vapor deposition (PVD) or plasma-assisted chemical vapor deposition (PACVD). At least one of the rings of the bearing could equally be impregnated using other impregnation techniques.

### BRIEF DESCRIPTION OF THE DRAWINGS

The present invention will be better understood upon studying the detailed description of embodiments taken by way of nonlimiting example and illustrated in the appended drawings, in which:

FIG. 1 is a perspective view of a roller device including a bearing including a coating according to one embodiment of the invention.

FIG. 2 is a perspective view of a rolling bearing including a coating according to a second embodiment of the invention.

### DETAILED DESCRIPTION

The expressions “exterior” and “interior” refer to the rotation axis Y-Y of the bearings, the interior parts are nearer the rotation axis than the exterior parts.

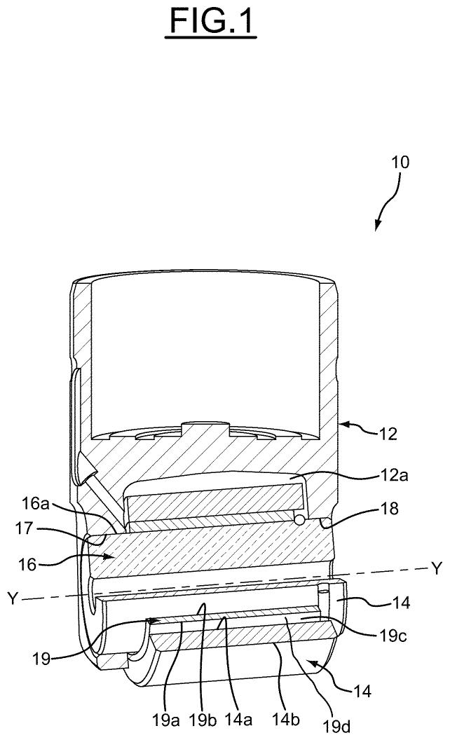

In FIG. 1 there is represented a cam follower roller device, designated by the general reference 10, usable, for example, in a fuel injection pump intended for an internal combustion engine.

The device 10 includes a push-rod or body 12 and a roller 14 mounted to rotate relative to the body and intended to come to bear against a cam synchronized with a camshaft of the internal combustion engine or directly against a cam of said shaft. The body 12 delimits an opening 12a open toward the exterior and inside which the roller 14 is mounted. The roller 14 projects radially out of the body 12. The body 12 may advantageously be obtained at low cost by forging or by cutting, pressing and bending from a thin plate blank.

The device 10 also includes a shaft 16, with axis Y-Y, mounted on the body 12 and supporting the roller 14. The support shaft 16 has a cylindrical axial exterior surface 16a around which the roller 14 is mounted. The ends of the shaft 16 are mounted inside through-orifices 17, 18 produced on the body 12 and axially facing one another The shaft 16 is fixed to the body 12 by any appropriate means. The portion of the exterior surface 16a left free by the body 12 forms an exterior mounting bearing surface. The exterior bearing surface is situated axially between the ends of the shaft 16 accommodated inside the holes 17, 18 in the body.

The roller 14 includes a cylindrical axial bore 14a forming an interior surface and a cylindrical axial exterior surface 14b radially opposite said bore. The exterior surface 14b of the roller forms a contact surface intended to come to bear against the associated cam of the internal combustion engine.

The device 10 further includes a plain bearing 19 disposed radially between the roller 14 and the shaft 16. The plain bearing 19 takes the form of an annular sleeve and is coaxial with the roller 14 and the shaft 16. The bearing 19 has a cylindrical axial exterior surface 19a mounted radially in contact against the bore 14a of the roller 14 and an opposite cylindrical axial bore 19b mounted radially in direct contact with the exterior bearing surface of the bearing 19.

The exterior bearing surface of the shaft 16 forms a mounting bearing surface for the plain bearing 19 that supports the roller 14. The plain bearing 19 may be fixed to the roller 14 or to the shaft 16 or again mounted to rotate freely between them. The roller 14 is mounted to rotate freely relative to the exterior bearing surface of the shaft 16.

In the example illustrated, the roller 14 is mounted to move freely in translation relative to said exterior bearing surface of the shaft 16.

The plain bearing 19 is made of a material configured to limit friction between the roller 14 and the shaft 16. For example, the plain bearing 19 may be made of amorphous carbon (DLC).

The plain bearing 19 has on its exterior surface 19a and/or on its bore 19b a coating 19c that may be deposited, for example, by vacuum deposition techniques, for example by physical vapor deposition (PVD) or plasma-assisted chemical vapor deposition (PACVD). At least one of the rings of the bearing could equally be impregnated or coated using other impregnation or coating techniques.

The coating includes one or more nanosensors 19d integrated into said coating. For example, the nanosensors may be in the form of nanoparticles.

A nanoparticle sensor or nanosensor characterizes any sensor effecting an operation at the nanometric scale and configured to transmit a signal at the macroscopic scale.

By “nanoparticle” is meant a nano-object the three dimensions of which are at the nanometric scale, that is to say a particle the nominal diameter of which is less than approximately 100 nm.

Each of the nanosensors 19d is configured to communicate wirelessly with a receiver (not represented) external to the plain bearing 19.

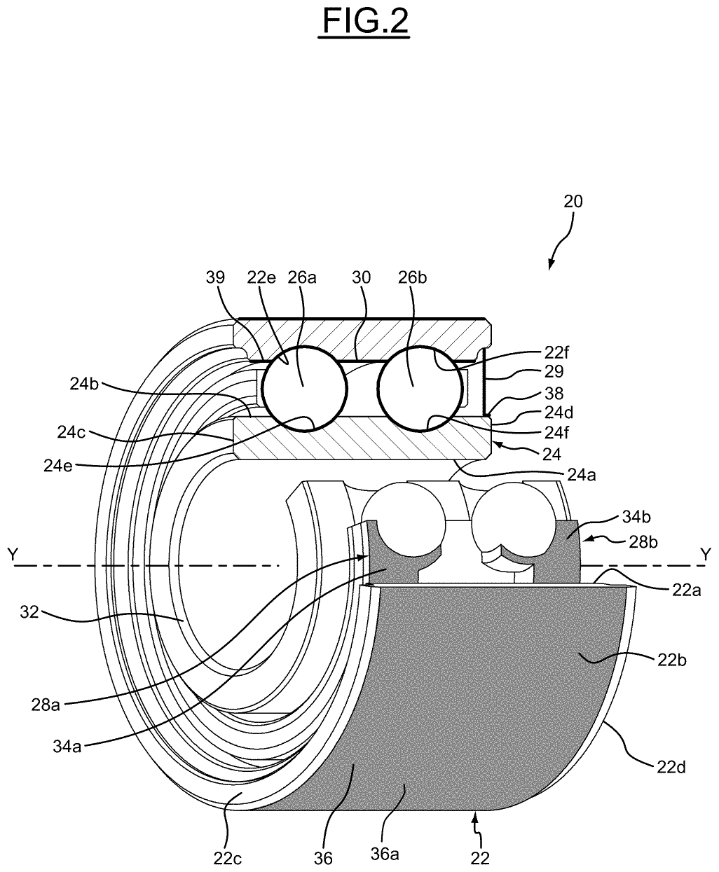

In FIG. 2 there is represented a rolling bearing, with reference number 20 as a whole, such as a bearing with two rows of balls.

The rolling bearing 20 includes an exterior ring 22, an interior ring 24, and two rows 26a, 26b of rolling elements disposed radially between said rings 22, 24. As illustrated, the rolling elements are balls. Alternatively, there could be other types of rolling elements, such as for example rollers or needles. A single row of rolling elements could equally be provided.

As illustrated, the rolling elements of each row of rolling elements 26a, 26b are retained circumferentially inside a cage 28a, 28b. Each cage 28a, 28b may include a plurality of pockets configured to house the rolling elements and to retain them with a regular circumferential spacing.

As illustrated, the interior ring 24 is solid and is delimited radially by an interior cylindrical surface 24a and an exterior cylindrical surface 24b and axially by two opposite front radial surfaces 24c, 24d.

The interior ring 24 includes on its cylindrical exterior surface 24b two toroidal grooves 24e, 24f forming raceways for the rolling elements. The interior ring 24 may be fabricated by turning or shaping a steel blank, said blank being then straightened and where applicable lapped at the location of the raceway in order to impart to the interior ring 24 its geometrical characteristics and its final surface state.

As illustrated, the exterior ring 22 is solid and is delimited radially by a cylindrical interior surface 22a and a cylindrical exterior surface 22b and axially by two opposite front radial surfaces 22c, 22d.

The interior cylindrical surface 22a of the exterior ring 22 includes two toroidal grooves 22e, 22f forming raceways for the rolling elements.

Alternatively, a rolling surface for the rolling elements could be provided on the cylindrical interior surface 22a of the exterior ring 22.

The exterior ring 22 may be fabricated by turning or shaping a steel blank, said blank then being straightened and where applicable lapped at the location of the raceway in order to impart to the exterior ring 22 its geometrical characteristics and its final surface state.

As illustrated, the rolling bearing 20 includes a sealing element 29 mounted radially between the rings 22, 24. Alternatively, two sealing elements could be provided, mounted radially between the rings 22, 24 on each side of the rolling elements 26a, 26b. As illustrated, the sealing element 29 is a radial seal including a sealing lip (no reference number) in radial rubbing contact on the exterior surface 24b of the interior ring 24. Alternatively, the sealing lip of the sealing element could be in radial rubbing contact against the interior surface 22a of the exterior ring 22.

As illustrated, the rolling bearing 22 further includes a first coating 30 situated on the interior surface 22a of the interior ring 22, in particular on the two toroidal grooves 22e, 22f forming raceways for the rolling elements.

As illustrated, the rolling bearing 20 includes a second coating 32 situated on the interior surface 24a of the interior ring 24.

As illustrated, the rolling bearing 20 includes a third coating 34b, 34b situated on each of the cages 28a, 28b, in particular on their exterior surface. Alternatively, the third coating 34b, 34b could be situated on the interior surface of each of the cages or on one of the lateral sides of the cages

As illustrated, the rolling bearing 20 includes a fourth coating 36 situated on the exterior surface 22b of the exterior ring 22.

As illustrated, the rolling bearing 20 includes a fifth coating 38 situated on the sealing lip of the sealing element 29.

As illustrated, the rolling bearing 20 includes a sixth coating 39 situated on each of the rolling elements.

Each of the coatings 30, 32, 34a, 34b, 36, 38, 39 includes one or more nanosensors, e.g., sensor 36a of the coating 36, integrated into said coating. For example, the sensors may be in the form of nanoparticles.

The nanosensors may be identical or different from one coating to another.

Each of the nanosensors is configured to communicate wirelessly with a receiver (not represented) exterior to the rolling bearing 20. Each of the coatings 30, 32, 34a, 34b, 36, 38, 39 is deposited on the associated surface using vacuum deposition techniques, for example by physical vapor deposition (PVD) or plasma-assisted chemical vapor deposition (PACVD). At least one of the rings of the bearing could equally be impregnated or coated using other impregnation or coating techniques.

In the example illustrated in FIG. 2 the rolling bearing includes a plurality of coatings including one or more nanosensors. Alternatively, the rolling bearing could include a different number of coatings, for example only one coating, two, three, four or five coatings, or a number greater than six coatings.

The coating could be applied to any type of bearing or rolling bearing, such as for example a clutch thrust bearing.

Thanks to the integration into a bearing of a coating with nanosensors the time to assemble the sensors onto the bearings is reduced and the surveillance of the state of the bearings is improved.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearings having nanosensor coatings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing including at least one coating including at least one sensor integrated into said coating, said sensor being a nanosensor that includes at least one nanoparticle.

2. The bearing according to claim 1,
wherein the bearing comprises a plurality of elements including at least one exterior ring and one interior ring, and
wherein the coating is disposed on at least one element of the plurality of elements.

3. The bearing according to claim 2, wherein the coating is disposed radially between the exterior ring and the interior ring.

4. The bearing according to claim 3, wherein the coating is deposited on the interior surface and/or the exterior surface of the exterior ring.

5. The bearing according to claim 4, in which the coating is deposited on the interior surface and/or the exterior surface of the interior ring.

6. The bearing according to claim 2,
wherein the plurality of elements include at least at least one row of rolling elements and a cage configured to maintain a circumferential spacing between said rolling elements,
wherein the exterior surface of the inner ring includes an inner raceway,
wherein the interior surface of the outer ring includes an outer raceway, and
wherein the coating is disposed on each of the rolling elements and/or on the cage.

7. The bearing according to claim 6, wherein the rolling elements are balls.

8. The bearing according to claim 2,
wherein the plurality of elements include at least one sealing element mounted radially between the exterior ring and the interior ring, and
wherein the coating is disposed on at least a portion of the sealing element.

9. The bearing according to claim 2,
wherein the bearing is a plain bearing, and
wherein the coating is disposed on an exterior surface of the plain bearing and/or on a bore of said plain bearing.

10. A coating configured to be deposited on at least one element of a bearing and including at least one sensor integrated into said coating, said sensor being a nanosensor that includes at least one nanoparticle.

11. The bearing according to claim 2,
wherein the nanosensor is configured for wireless communication with a receiver external to the bearing.

12. The bearing according to claim 11,
wherein the coating includes graphene.

13. A bearing comprising:
an exterior ring having at least one surface;
an interior ring having at least one surface; and
at least one coating on the at least one surface of the exterior ring or on the at least one surface of the interior ring,
wherein the coating includes at least one nanosensor configured for wireless communication with a receiver external to the bearing.

14. The bearing according to claim 13,
wherein the coating includes graphene.

15. The bearing according to claim 13, wherein the bearing is a plain bearing.

16. The bearing according to claim 13,
wherein the bearing includes a plurality of rolling elements and a cage disposed between the exterior ring and the interior ring.
